(19) United States
(12) Patent Application Publication
(10) Pub. No.: US 2003/0205148 A1
(43) Pub. Date: Nov. 6, 2003

(54) Anti-rotational cup holder

(76) Inventors: Stuart A. Rubin, Plymouth, MN (US); James K. Knudsen, Carol Stream, IL (US)

Correspondence Address: The Kinney & Lange Building, 312 South Third Street, Minneapolis, MN, 55415-1002, US

(21) Appl. No.: 10/169,542

(22) PCT Filed: Jan. 12, 2000
(86) PCT No.: PCT/US00/00775

(30) Foreign Application Priority Data
Jan. 10, 2000 (US) 60175197

(51) Int. Cl. A23C 1/00

(52) U.S. Cl. 99/452

(57) ABSTRACT

A cup holder (10) for nonrotatable holding a beverage container during mixing of the pre-frozen beverage ingredients therein is described. The cup holder is removably supported in a cup holder support structure while the ingredients inside the beverage cup are processed, such as by mixing by a rotating blade. The cup holder (10) has anti-rotational features (18) on its sidewall and/or bottom wall structures, so that the cup holder is restrained against rotation which would otherwise be caused by the action of the rotating blade or other processing tool within the beverage cup. In a preferred embodiment, a spirally radiating anti-rotation pattern is formed on the cup holder bottom for mating with a corresponding pattern on the cup holder support structure.

### BACKGROUND OF THE INVENTION

The creation of food and beverage mixtures often involves the use of a rotational means for blending, whipping or stirring of the mixture using a mixer. The ingredients are held in a container while the mixing or rotational means is introduced into the container until the desired mixture is obtained. The present invention relates to holders for such containers during the mixing process.

In U.S. Pat. No. 5,803,377, a method for making frozen drinks is described. The patent describes an apparatus which allows the formation of milkshakes and other frozen drinks by breaking up pre-frozen blocks of ingredients into small frozen particles using a rotating blade, and blending them with an added liquid. The ingredients of the pre-frozen blocks are mixed in liquid form, placed into serving cups and frozen into blocks conforming to the insides of the serving cups. The serving cups are stored frozen until they are ready for use. The serving cups are the same serving cups in which the finished milkshake or frozen drinks are served to the consumer.

According to the disclosure, when a milkshake or other frozen drink is to be made, a serving cup containing the frozen block is positioned in a cup holder which forms a part of the frozen drink machine. A rotating blade is lowered into the cup and bores through the frozen substance in the cup, grinding it into small frozen particles. Milk, water, or another liquid is added to the cup up and is blended into the frozen substance by the rotating blade. The rotating blade also whips air into the frozen particle mixture in order to give the milkshake or frozen drink its proper volume, texture, and flavor delivery.

In U.S. Pat. No. 6,041,961, a container for containing food and/or beverage ingredients is described. The patent discloses a container for holding ingredients to be processed by a rotating blade or other mechanism. The container, for example, could be the serving cup used in the apparatus of U.S. Pat. No. 5,803,377. While the ingredients are processed, the container is restrained against rotation that would normally be caused by the rotating blade or processing tool. The container of U.S. Pat. No. 6,041,961 has an anti-rotation pattern formed on the exterior surface of the container. During use, the container is positioned in a cup holder of a beverage mixing apparatus having a corresponding pattern so that the anti-rotation pattern on the container engages with the corresponding pattern on the cup holder to inhibit rotation of the container during usage.

### BRIEF SUMMARY OF THE INVENTION

The present invention relates to a cup holder for receiving a beverage cup therein and which is receivable by a beverage mixing support apparatus. The inventive cup holder has a side wall structure and a bottom wall structure, with the side and bottom wall structures together defining a cup receiving cavity with an open top. The beverage cup is placed within the receiving cavity of the cup holder through the open top. The cup holder non-rotatably holds the beverage cup in an upright position within the receiving cavity. At least one of the side and bottom wall structures of the cup holder includes an anti-rotation pattern thereon, with the anti-rotation pattern including at least one inwardly or outwardly protruding portion engageable with a corresponding protruding portion in a beverage mixing apparatus. When the protruding portions are engaged with one another, rotational movement of the cup holder is inhibited relative to the beverage mixing support apparatus, without preventing longitudinal movement of the cup holder relative to the beverage mixing support apparatus.

In one preferred embodiment, the anti-rotation pattern includes an engageable protruding portion formed on or into the cup holder bottom wall structure. The protruding portion preferably includes one or more ridges radiating outwardly from the center of the bottom wall structure. At least one of the radiating ridges is preferably arcuate and each ridge may have a substantially triangular cross-section. In an alternative embodiment, the anti-rotation pattern includes an engageable protruding portion formed on or into the cup holder sidewall structure. Preferably, the protruding portion on the sidewall structure includes one or more spaced ribs or indents, or has at least one vertically disposed flat surface.

The invention is alternatively defined as a method for non-rotatably securing a beverage cup in a beverage mixing machine, where the beverage cup has a pre-frozen substance mixture therein. The inventive method includes placing a beverage cup with a cavity in a cup holder, with the cup holder non-rotatably holding the beverage cup in an upright position in its cavity. The cup holder is then placed in nonrotatable engagement with a beverage mixing support apparatus of the beverage mixing machine. The pre-frozen substance mixture within the beverage cup is blended by engagement with a rotating blade while the cup and cup holder are restricted from rotation. After blending is complete, the cup holder is removed from the beverage mixing support apparatus, and the beverage cup separated from the cavity of the cup holder. Alternatively, the beverage cup is first removed from the cup holder, and then the cup holder removed from the beverage mixing support apparatus.

### BRIEF DESCRIPTION OF THE DRAWINGS

The present invention will be further explained with reference to the drawing figures referenced below, wherein like structure is referred to by like numerals throughout the several views.

FIG. 1 is a bottom perspective view of a cup holder according to the present invention.

FIG. 2 is a top perspective view of a cup holder according to the present invention.

FIG. 3A is a side view of a beverage cup and cup holder according to the present invention, prior to insertion of the beverage cup into the cup holder.

FIG. 3B is a side view of a beverage cup and cup holder according to the present invention, after insertion of the beverage cup into the cup holder.

FIG. 4 is a bottom view of the cup holder of FIG. 1.

FIGS. 5A, 5B and 5C are partial sectional views of the cup holder bottom shown in FIG. 4, taken along the lines designated 5A-5A, 5B-5B and 5C-5C, respectively.

FIG. 6A is a front elevation view of a beverage mixing apparatus of a type which may be used with the cup holder of the present invention.

FIG. 6B is an enlarged front elevation view of the cup holder of the beverage mixing apparatus of FIG. 6A.

FIG. 7 is a perspective view of an anti-rotation pattern positioned within a cup holder for the beverage mixing apparatus of FIG. 6A and which may be used to support the cup holder of the present invention.

FIG. 7A is a top plan view of an alternative cup holder support structure.

FIG. 7B is a side elevational view, as taken along lines 7B-7B in FIG. 7A.

FIG. 7C is a side elevational view, as taken along lines 7C-7C in FIG. 7A.

FIG. 8 is a side section view of a beverage cup in a cup holder according to the present invention, showing the blade from the beverage mixing apparatus of FIG. 6A being lowered into the beverage cup, and further showing the circular recessed portions of the beverage cup and cup holder bottoms as the opposed anti-rotation patterns.

FIG. 9 is a side elevation view of an alternative embodiment of a cup holder according to the present invention.

FIGS. 10A and 10B are a side section view and a bottom view, respectively, of an alternative embodiment of a cup holder according to the present invention.

FIGS. 11A and 11B are a side elevation view and a bottom view, respectively, of an alternative embodiment of a cup holder according to the present invention.

FIG. 11C is a cross-sectional side view of the cup holder bottom of FIG. 11B, taken along the line designated 11C-11C in FIG. 11B.

FIG. 12 is a top perspective view of an alternative embodiment of the cup holder according to the present invention.

FIG. 13A is a top perspective view of an alternative embodiment of the cup holder according to the present invention.

FIG. 13B is a top view of the cup holder of FIG. 13A, in combination with a rotational stop of a beverage mixing apparatus.

FIG. 14 is a side view of an alternative embodiment of the cup holder according to the present invention, with a beverage cup received therein.

While the above-identified drawings set forth several preferred embodiments, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of this invention.

### DETAILED DESCRIPTION

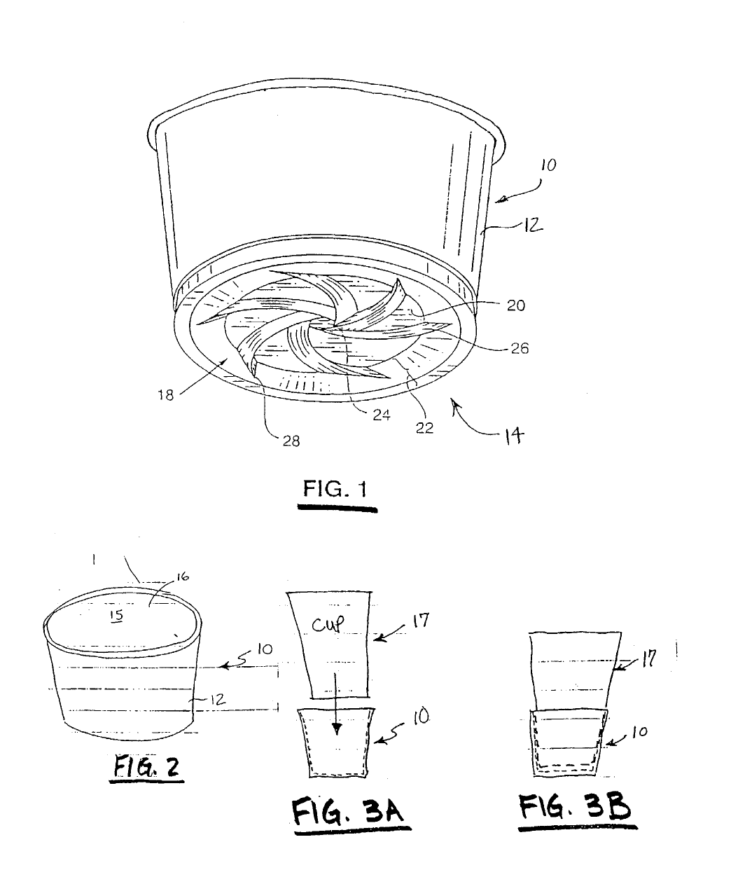

FIG. 1 shows a bottom perspective view of a cup holder 10 according to the present invention. The inventive cup holder 10 includes a generally cylindrical side wall structure 12 and a circular bottom wall structure 14. The bottom wall structure 14 is attached to the side wall structure 12 and together they define a cup receiving cavity 15, as shown in FIG. 2. As also shown in FIG. 2, the cup holder 10 has an open top 16 for receiving a beverage cup therein. FIGS. 3A and 3B show a beverage cup 17 in relation to the cup holder 10, with the beverage cup 17 received within the cavity holder 15 of the cup in FIG. 3B.

During use, the beverage cup 17 contains pre-frozen food or beverage ingredients that are to be processed inside the beverage cup using a rotating blade or other boring and/or blending device. The side wall structure 12 of the cup holder 10 is generally cylindrical (tapering larger toward the open top 16) and dimensioned to receive a lower portion of a standard beverage cup, such as the cup 17. In the illustrated embodiment, the side wall structure 12 is circular in lateral cross-section. In optional embodiments, however, the side wall structure could be of any suitable shape, such as a square or triangular. The cup holder 10 is formed to non-rotatably hold a beverage cup in an upright position. As noted above, the cavity 15 in the side wall structure 12 preferably has an interiorly tapered side wall to better hold a beverage cup therein.

At least one of the side or bottom wall structures of the cup holder 10 includes an anti-rotation pattern on its exterior. The anti-rotational pattern is designed to engage with a cup holder support structure of a beverage mixing apparatus so as to prevent rotation of the cup holder during processing of the material within the cup held by the cup holder.

In one embodiment, an anti-rotation pattern 18 (FIG. 1) is formed in the cup bottom wall structure 14. The anti-rotation pattern 18 includes at least one inwardly or outwardly protruding portion which is engageable with a corresponding protruding portion in a beverage mixing apparatus. The anti-rotation pattern thus can be used to restrict rotational movement of the cup holder relative to the beverage mixing apparatus. When the opposed protruding portions are engaged with one another, the anti-rotational pattern restricts rotational movement without preventing longitudinal movement of the cup holder relative to the beverage mixing support apparatus.

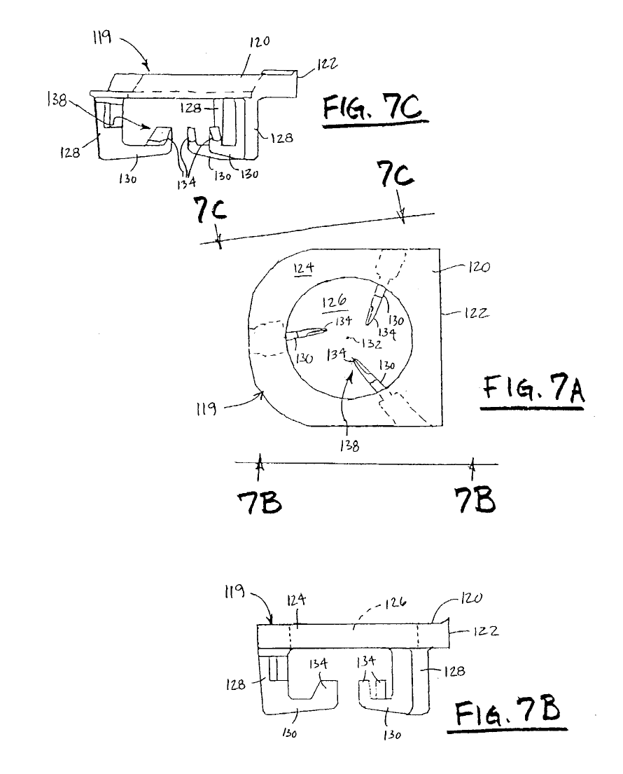

In a preferred embodiment, the anti-rotation pattern 18 is in the form of the pinwheel pattern shown in FIGS. 1 and 4. The pattern 18 is designed to mate with a corresponding pinwheel pattern 18a (see FIG. 7) in a cup holder support structure 19 (on or in relation to the beverage mixing apparatus) which holds the cup holder 10 during processing of the food or beverage ingredients inside the beverage cup 17. The pattern 18 should therefore include at least one inwardly or outwardly protruding portion which engages a corresponding mating pattern 18a on the cup holder support structure 19.

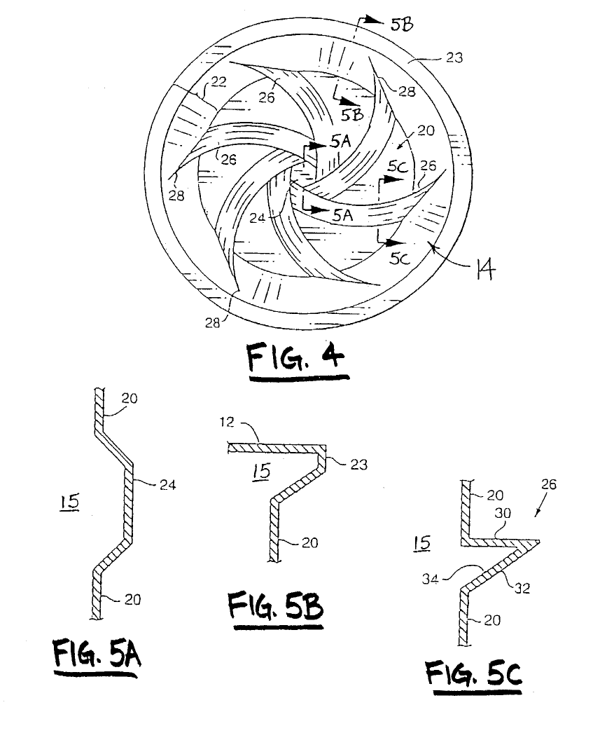

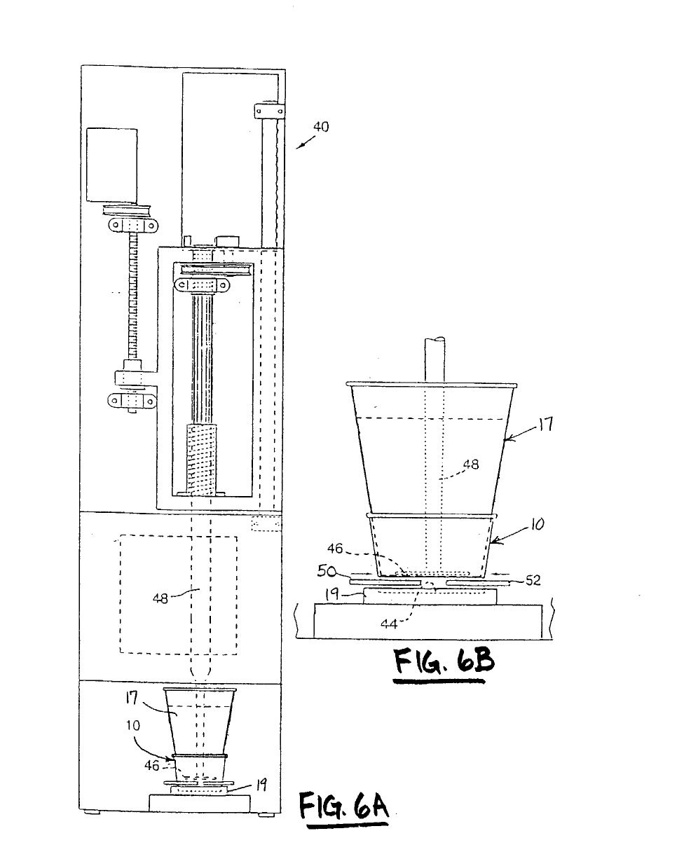

Referring to FIG. 4, the bottom wall structure 14 includes a circular center section 20 and a circumferential section 22 surrounding the center section 20. The circumferential section includes an edge section 23 which is recessed below the center section 20 (as viewed from the cup interior cavity 15) (see FIG. 5B). The cup bottom wall structure 14 further includes a recessed center portion 24 (as viewed from the cup interior cavity 15), centered in the circular center section 20 as shown in FIG. 5A. Recessed center portion 24 may have a non-circular shape, such as the six-sided shape shown in FIG. 4. By giving center portion 24 a non-circular shape, it contributes to the anti-rotation features of the cup holder 10 by mating with a correspondingly shaped section in the cup holder support structure. As shown in FIG. 8, the center portion 24 may be alternatively provided as the sole anti-rotation pattern.

Referring again to FIGS. 1 and 4, the anti-rotation pattern 18 includes a plurality of ridges 26 radiating from the recessed center portion 24 of the bottom wall structure 14 and extending downwardly from the bottom surface of center section 20 of the bottom wall structure 14. At least one of the radiating ridges is arcuate, and preferably, as shown in FIG. 4, all of the radiating ridges are arcuate (although other shapes and geometries will suffice). A trailing edge 28 extends from each arcuate ridge 26 into the circumferential section 22 of the bottom wall structure 14.

As shown in FIG. 5C, each arcuate ridge 26 preferably has a triangular cross-section, formed by a first side wall 30 which is approximately vertically oriented with respect to the center section 20, and a second side wall 32 which extends angularly between center section 20 and first side wall 30. In a preferred embodiment of the cup holder, the walls 30, 32 are joined at an angle of approximately 45°. The portion of the ridge 26 facing the cup interior cavity 14 forms a groove 34.

The triangular configuration of the anti-rotation pattern enhances the rigidity of the cup holder during use by creating a triangular structural element. The first side wall 30 is approximately straight up and down. Thus, as it resists rotation by pressing against the corresponding protruding portion of the beverage mixing apparatus, there is no upward force created, as would be the case if it were angled like the other second side wall 32. In fact, by bringing this face past vertical, a downward force can be generated which helps to keep the cup seated on the cup holder as torque is applied. Another advantage of the angled side wall 32 of the anti-rotation pattern 18 in the bottom wall structure 14 is that this angle acts as a self aligning mechanism, so that if a cup holder 10 is placed in the cup holder support structure 42 and the sloped side wall 32 contacts the corresponding mating member of the cup holder 10 before the cup holder 10 is fully seated, the angle of wall 32 causes the cup holder 10 to twist slightly so that the cup holder 10 slides into a fully engaged position within the anti-rotation pattern in the cup holder support structure. Therefore, little care is required to properly place the cup holder in the cup holder support structure. The anti-rotation pattern on the cup holder support structure may also be tapered or angled to facilitate quick and accurate seating of the cup holder.

It should be noted that shapes other than a triangular cross-section, such as a rectangular cross-section, would also be quite effective in preventing rotation and (as with the triangular cross-section) would have the benefit of added strength due to their wide cross-section at the point where they meet the cup bottom.

In use, a beverage cup 17 is received within the cup holder 10. In a preferred embodiment, the beverage cup 17 nests within the cavity 15 of the cup holder 10 and is retained therein by frictional engagement between the beverage cup's side walls and the interior wall of the cavity 15 of the cup holder 10 (each component may have tapered side walls, such as illustrated in FIGS. 3A and 3B). Alternatively, the beverage cup 17 and cup holder 10 may be non-rotatably engaged by other means, such as complimentary engaging/protruding portions on their respective side walls or bottom walls. Regardless of how coupled together for beverage processing, the beverage cup 17 and cup holder 10 can be readily separated (longitudinally) once processing is completed so that the beverage mixture in the cup 17 can be served without the cup holder 10 thereon.

Once the beverage cup 17 is properly seated in the cup holder 10, the cup holder 10 is then engaged with the beverage mixing apparatus. The engagement of the cup holder with the beverage mixing apparatus is accomplished by any means within the scope of this disclosure. The engagement of the cup holder 10 with the beverage mixing apparatus restricts rotational movement of the cup holder 10 relative to the beverage mixing apparatus. The frozen substance contained within the beverage cup 17 is mixed using a blending means. The mixing of the substance within the beverage cup 17 is performed without rotating the beverage cup 17 or the cup holder 10 relative to the beverage mixing apparatus. Once mixing is complete, the cup holder 10 is disengaged from the beverage mixing apparatus and the beverage cup 17 is removed from the cup holder 10.

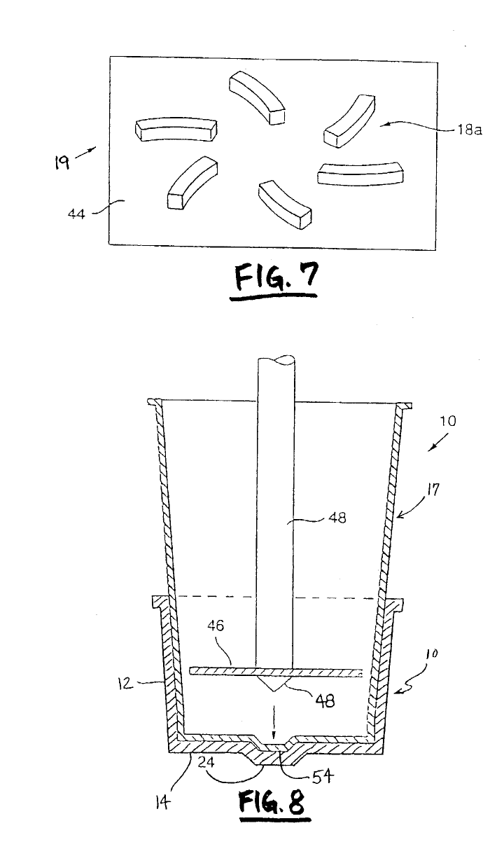

FIG. 6A illustrates a frozen drink machine 40 of a type that may utilize a cup holder 10 according to the present invention. The frozen drink machine 40 includes a cup holder support structure 19 having a recessed portion 44 (FIG. 6B) for receiving the cup holder 10. As shown in FIG. 7, recessed portion 44 includes the anti-rotation pattern 18a designed to mate with anti-rotation pattern 18 on the bottom wall structure 14 of the cup holder 10. The frozen drink machine 40 further includes a rotatable blade 46 that rotates on a shaft 48. Rotatable blade 46 may include a protruding tip 48 (FIG. 8).

During use of the cup holder 10 with the frozen drink machine 40, the cup holder 10 is positioned in recessed portion 44 of cup holder support structure 19 as shown in FIGS. 6A and 6B. While the cup holder 10 is shown as having a height shorter than the beverage cup 17 it receives, it is contemplated that the cup holder be as tall (or even taller) than its respective beverage cup. The anti-rotation pattern 18 in the cup holder 10 mates with the corresponding anti-rotation pattern 18a in the cup holder support structure 19, so that the cup holder 10 and the beverage cup 17 contained therein remain in place during grinding and blending by means of rotation of the blade 46. The frozen drink machine 40 may be equipped with opposed cup gripping members 50, 52 (FIG. 6B) that move into contact with the exterior surface of the cup holder 10 so as to restrain the cup holder 10 against movement out of the cup holder support structure 19 during processing.

Rotatable blade 46 is lowered into the beverage cup 17, where it grinds the frozen ingredients in the cup 17 and where it blends the ground frozen ingredients with an added liquid (provided by frozen drink machine 40). Tip 48 helps the blade 46 to remain centered in the beverage cup 17 when the blade 46 is boring into the frozen ingredients in the cup 17.

As shown in FIG. 8, if the beverage cup 17 has a recessed center portion 54 on its bottom wall that corresponds with the recessed portion 24 of the cup holder 10, the tip 48 of the blade 46 can extend into the recessed portion of the beverage cup 17 when the blade 46 is at the bottom of the beverage cup 17. This allows the blade 46 to reach the bottom of the cup 17 and therefore avoids puncturing the bottom of the cup 17 or leaving a layer of frozen ingredients on the bottom of the cup 17. The pattern 18 shown in FIG. 1 is not shown in FIG. 8 for clarity.

It should be understood, however, that the recessed portion 24 itself might serve as the anti-rotation pattern if used with a corresponding pattern on the cup holder support structure of the frozen drink machine.

After reaching the end of its downward travel, the spinning blade moves upwardly until it eventually passes out of the cup. At this point, the frozen mixture in the cup has been mixed and is ready for serving to a consumer in the cup, such as in the form of a milk shake or smoothie.

FIGS. 7A, 7B, and 7C illustrate a preferred embodiment of a cup holder 119, designed for use in connection with the spiral configurations of the bottom wall structure 14 of the cup holder 10 of FIGS. 1 and 4. The cup holder support structure 119 has a frame 120 which is affixed to the frozen drink machine 40, such as along a side 122 thereof. The frame 120 has a generally horizontal member 124 with a circular cup receiving aperture 126 therethrough. A plurality of arms 128 are mounted to the frame 120 and depend downwardly therefrom. Each arm 128 has an inner extension 130 which extends generally radially toward the center 132 of the aperture 126 (although at a slight tangent thereto). Each extension 130 has an upwardly projecting tab 134 thereon, and the tabs are arranged to define an anti-rotation pattern 138 designed to mate with the anti-rotation pattern 18 on the bottom wall structure 14 of the inventive cup holder 10. As seen in FIG. 7C, the tabs 134 are tapered to facilitate quick and accurate seating of the cup holder 10 on to the anti-rotation pattern 138 of the cup holder support structure 119.

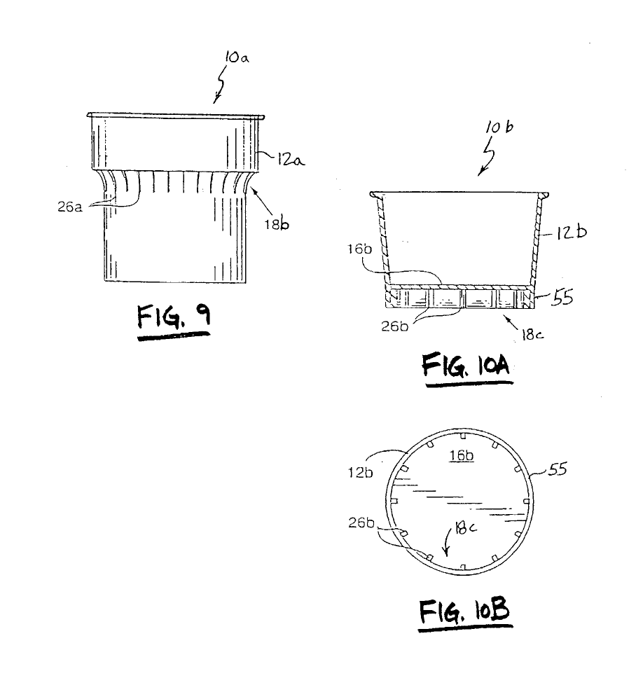

The anti-rotation pattern does not need to be on the bottom wall structure of the cup holder. It may be on the side wall structure and/or the bottom wall structure. For example, referring to the alternative embodiment for a cup holder 10a in FIG. 9, a cup side wall 12a may include an anti-rotation pattern 18b formed of a plurality of longitudinally extending ribs or fins 26a on its exterior surface. The cup holder support structure (not shown) for cup holder 10a is provided with a corresponding anti-rotation pattern, such as one or more grooves, ribs or fins which engage with the ribs 26a to limit rotation of the cup holder 10a relative to the cup holder support structure.

Although placing the anti-rotation pattern on the side walls of a cup holder works well for preventing rotation, there are several reasons that make it beneficial to position the anti-rotation pattern on or nearer to the cup holder bottom. For instance, including the anti-rotation pattern at the cup holder bottom rather than on the side walls is advantageous in that the downward pressure of the boring blade 46 forces the beverage cup 17 and the cup holder 10 downwardly into the cup holder support structure 19. This keeps the cup holder 10 and cup holder support structure 19 engaged with one another during the critical boring phase of the frozen drink machine's processing cycle, when torque on the cup holder (via the beverage cup) is at its maximum. It is also advantageous to have the anti-rotation pattern at the region of the cup holder adjacent where the frozen ingredients will remain for the longest period of time during boring by boring blade 46 in the beverage cup, i.e., at or near the cup holder bottom.

Regardless of how the cup holder non-rotatably engages the cup holder support structure of a frozen drink machine, the cavity in the cup holder may be sized to receive (non-rotatably) beverage cups of different sizes. Thus, a single cup holder may be used with a variety of beverage cup sizes.

FIGS. 10A through 10B illustrate an alternative embodiment of a cup holder according to the present invention which utilizes an anti-rotation pattern adjacent the bottom of the cup holder. In this embodiment, the side wall 12b of the cup holder 10b extends downwardly past the cup bottom wall structure 16b to form a skirt 55, and an anti-rotation pattern 18c is formed on an interior surface of the skirt 55. In the embodiment of FIGS. 10A and 10B, the anti-rotation pattern 18c is in the form of longitudinally oriented ribs 26b, but may take the form of recesses or ribs in various patterns.

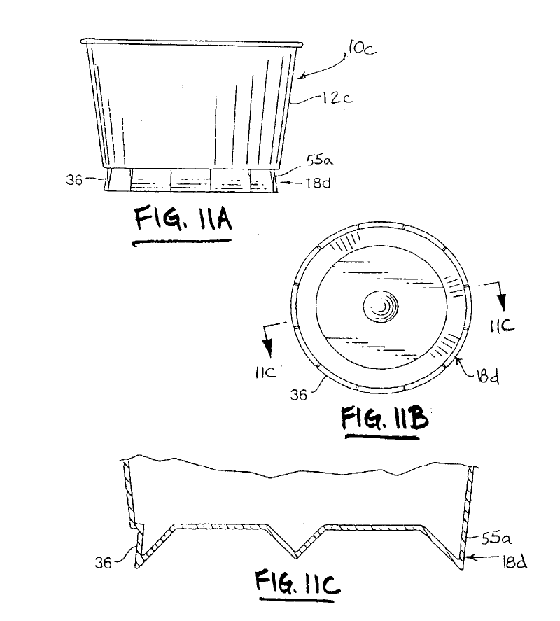

Another alternative embodiment of a cup holder 10c, shown in FIGS. 11A and 11B, utilizes an anti-rotation pattern 18d on reverse tapered portions of a skirt 55a of the side wall 12c. In this embodiment, a region of the side wall 12c has a slightly reduced diameter to form a nesting/stacking shoulder 36, as is commonly found in thermo formed cups (see also FIG. 11C). This region of the side wall 12c has a reverse inward taper, as opposed to the outward taper of the balance of the side wall 12c. In the embodiment shown in FIGS. 11A and 11B, the anti-rotation pattern 18d is located below the nesting/stacking shoulder 36, in the reverse tapered portion of the skirt 55a. As with the other embodiments, the anti-rotation pattern on the cup holder may take a variety of forms, including ribs, indentations, an octagonally shaped cup bottom or other texture patterns (protruding or recessed) on the surface that mates with corresponding features or shapes on the cup holder support structure.

FIG. 12 shows another embodiment of a cup holder 10d of the present invention, where the side wall structure 12d has at least one flat surface 60 for engaging a mating flat surface (not shown) on the cup holder support structure of a frozen drink mixing machine. Preferably (as shown), the side wall structure 10d has a plurality of flat surfaces 60 formed by a plurality of longitudinally aligned ribs 62, each of which extends substantially the entire height of the side wall structure of the cup holder 10d (although the ribs and flat surfaces need not extend the full height of the cup holder).

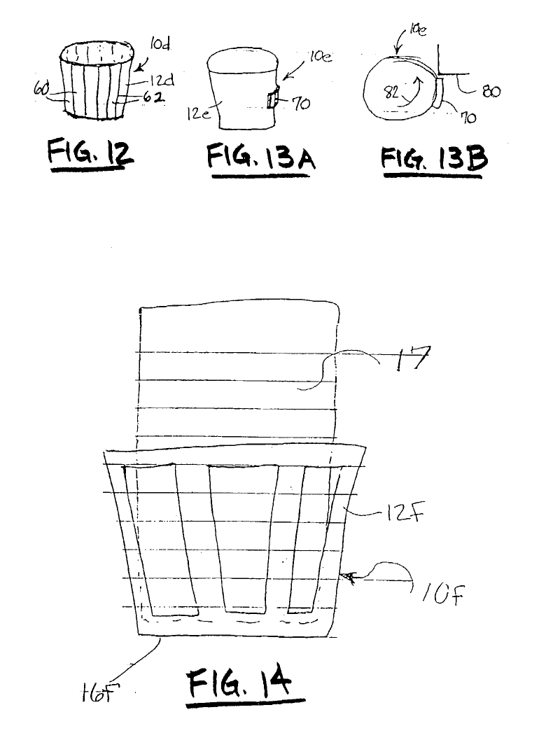

FIGS. 13A and 13B show another embodiment of an anti-rotational cup holder 10e of the present invention. The cup holder 10e has a side wall structure 12e which has a protruding lug 70 thereon. The protruding lug 70 mates with a stop 80 on the cup holder support structure of the beverage mixing apparatus to inhibit rotation of the cup holder 10e in direction of arrow 82.

FIG. 14 shows yet another embodiment of a cup holder 10f of the present invention. The cup holder 10f of FIG. 14 has a partially open side wall structure 12f joined to a circular bottom wall structure 16f. As shown, however, the side wall structure 12f of the cup holder 10f does not need to form a vessel or other container capable of holding a fluid (it has relatively open sides).

The cup holder is formed from a material suitable to be engaged by the cup holder support structure, such as metal or a relatively rigid polymer (e.g., polyethylene, PET, PVC, etc.) in such a way that it does not unduly bend or flex during mixing of the frozen substance in the cup. As noted, the cup is retained non-rotatably in the cup holder, either by cooperating structure or merely by friction. In one embodiment, the cup holder is formed from an elastomeric material (or at least has an elastomeric material inner coating or elastomeric features (e.g., ribs, nubs, etc.) for engaging the cup on an inner surface thereof. The elastomic portion of the cup holder thus slightly deforms upon insertion of a cup therein to enhance the frictional engagement between the cup and cup holder.

In a further alternative embodiment, the cup holder is non-rotatably engaged to a frozen drink machine by friction, as opposed to mere structural interaction. For example, the cup holder may be received frictionally in a recess on the cup holder support structure, or the cup may be retained from rotation merely by the gripping force of a clamp, such as the opposed cup gripping members 50, 52 in FIGS. 6A and 6B. In such embodiments, the outer surface of the cup holder (sides and/or bottom) and those surfaces of the cup holder support structure would have cooperative mechanical mating characteristics (e.g., like hook and loop fasteners) or one or both surfaces have elastomeric characteristics in order to enhance the coupling of the cup holder to its support structure in a non-rotatable manner.

The disclosure of each patent referenced herein is hereby incorporated by reference. Although the present invention has been described with reference to several preferred embodiments, workers skilled in the art will recognize that changes may be made in form and detail without departing from the spirit and scope of the invention. The present invention thus provides an anti-rotational cup holder for use in a beverage mixing apparatus that would replace or supplement serving cups which themselves have anti-rotational features. The inventive anti-rotational cup holder allows the use of various kinds of beverage cups with a beverage mixing apparatus, and does not limit use of the mixing apparatus to a single type of serving cup having anti-rotational features. Since any cup can be used with the beverage mixing apparatus by means of the inventive cup holder, an operator's choice of cup options is increased. Any typical beverage cup (paper or plastic) may be used, so long as it may be non-rotatably seated within the inventive cup holder yet readily removed therefrom.

1. A cup holder for receiving a beverage cup therein and which is receivable by a beverage mixing support apparatus, the cup holder comprising:
a side wall structure; and
a bottom wall structure attached to the side wall structure, the side and bottom wall structures together defining a cup receiving cavity formed to nonrotatably hold a beverage cup in an upright position therein, at least one of the side and bottom wall structures including an anti-rotation pattern thereon, the anti-rotation pattern including at least one inwardly or outwardly protruding portion engageable with a corresponding protruding portion in a beverage mixing apparatus in a manner which restricts rotational movement of the cup holder relative to the beverage mixing support apparatus without preventing longitudinal movement of the cup holder relative to the beverage mixing support apparatus when the protruding portions are engaged with one another.

2. The cup holder of claim 1 wherein the anti-rotation pattern includes an engageable protruding portion formed on or into the cup holder bottom wall structure.

3. The cup holder of claim 2 wherein the protruding portion includes one or more ridges radiating outwardly from the center of the bottom wall structure.

4. The cup holder of claim 3 wherein each ridge extends downwardly from the bottom wall structure.

5. The cup holder of claim 3 wherein each ridge has a substantially triangular cross-section.

6. The cup holder of claim 3 wherein at least one of the radiating ridges are arcuate.

7. The cup holder of claim 3 wherein all of the radiating ridges are arcuate.

8. The cup holder of claim 1 wherein the protruding portion is located on the side wall structure.

9. The cup holder of claim 8 wherein the protruding portion includes one or more spaced ribs or indents.

10. The cup holder of claim 8 wherein the side wall structure has at least one flat surface.

11. The cup holder of claim 1 wherein the cup receiving cavity has elastomeric features thereon to enhance a frictional engagement between the beverage cup and the cup holder.

12. A method for non-rotatably securing a beverage cup in a beverage mixing machine, wherein the beverage cup has a pre-frozen beverage mixture therein, the method comprising:
placing the beverage cup within a cavity in a cup holder, with the cup holder nonrotatably holding the beverage cup in an upright position therein;
placing the cup holder in nonrotatable engagement with a beverage mixing support apparatus of the beverage mixing machine;
blending the pre-frozen beverage mixture within the beverage cup by engagement of the frozen mixture in the cup with a rotating blade while the cup and cup holder are restricted from rotation;
removing the cup holder from the beverage mixing support apparatus; and
removing the beverage cup from the cavity of the cup holder.

13. The method of claim 12 wherein the step of placing the cup holder in nonrotatable engagement with the beverage mixing support apparatus includes engaging opposed anti-rotation portions on the support apparatus and a bottom wall structure of the cup holder.

14. The method of claim 13 wherein the opposed anti-rotation portions include one or more ridges radiating outwardly relative to the center of the bottom wall structure of the cup holder.

15. The method of claim 12 wherein the step of placing the cup holder in nonrotatable engagement with the beverage mixing support apparatus includes engaging opposed anti-rotation portions on the support apparatus and on a side wall structure of the cup holder.

16. The method of claim 12 wherein the cavity of the cup holder is provided with one or more elastomeric features for enhancing the frictional engagement between the beverage cup and the cup holder.

17. The method of claim 12, and further comprising:
disposing an elastomeric material between the cup holder and the beverage mixing support apparatus to enhance the frictional engagement therebetween.
